(19) United States
(12) Patent Application Publication
(10) Pub. No.: US 2019/0050163 A1
(43) Pub. Date: Feb. 14, 2019

(54) USING SNAP SPACE KNOWLEDGE IN TIERING DECISIONS

(71) Applicant: Seagate Technology LLC, Cupertino, CA (US)

(72) Inventors: Douglas William Dewey, Longmont, CO (US); Ian Davies, Longmont, CO (US)

(21) Appl. No.: 15/676,709

(22) Filed: Aug. 14, 2017

(51) Int. Cl. G06F 3/06

(52) U.S. Cl. CPC G06F 3/0647; G06F 3/0686; G06F 3/0604

(57) ABSTRACT

A storage system migrates pages of data based on a determination that the page includes snapshot data. Parameters associated with a page (e.g., a page rank) may be updated based on a determination that the page includes snapshot data. A tiering process may subsequently analyze the parameters to determine whether to migrate the page to a different storage tier. A share-write to a page that is referenced by the snapshot volume and a base volume is utilized to migrate pages that include snapshot data.

### BACKGROUND

Storage systems may include a plurality of storage devices separated into storage tier. For example, a storage system may include solid state storage allocated to a first storage tier and disc storage allocated to a second storage tier. Data may be stored in the storage tiers based on the access patterns associated with the data. For example, frequently accessed data may be stored in solid state storage, while infrequently access data may be stored in an archive tier, such as the disc storage.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

In at least one implementation, a method includes migrating a page from a first storage tier to a second storage tier of a storage system, the migration being based on the page including data corresponding to a volume snapshot of a volume of data stored across a plurality of storage devices of the storage system, the plurality of storage devices being allocated to one of at least the first storage tier and the second storage tier.

These and various other features and advantages will be apparent from a reading of the following Detailed Description.

### BRIEF DESCRIPTIONS OF THE DRAWINGS

FIG. 1 illustrates a block diagram of an example storage system for utilizing snap-space knowledge for tiering decisions.

FIG. 2 illustrates another block diagram of an example storage system for utilizing snap-space knowledge for tiering decisions.

FIG. 3 illustrates example operations for utilizing snap space knowledge in tiering decisions.

FIG. 4 illustrates example operations for utilizing snap space knowledge in tiering decisions

FIG. 5 illustrates an example schematic of a storage controller of a storage device.

### DETAILED DESCRIPTION

Storage systems may include a plurality of storage devices separated into storage tier. For example, a storage system may include solid state storage allocated to a first storage tier and disc storage allocated to a second storage tier. Data may be stored in the storage tiers based on the access patterns associated with the data. For example, frequently accessed data may be stored in solid state storage, while infrequently access data may be stored in an archive tier, such as the disc storage.

One or more virtualized storage volumes may be stored in such storage systems. Data associated with the virtualized volumes may be stored across the different storage tiers according to access patterns. A tiering manager manages the tiered storage and may migrate pages according to access patterns. On a periodic or scheduled basis, the storage systems may generate volume snapshots of a storage volume. The volume snapshot is a representation of a “state” of the storage volume. The state may indicate where pages of the storage volume are currently stored (e.g., in solid state storage or disc storage). The snapshots may be used to for data backup/archiving and may be stored in pages as part of the storage volume. Generally, these pages are likely to receive little or no future input/output (I/O).

Implementations described herein provide a storage system that migrates pages of data based on a determination that the page includes snapshot data. In some implementations, parameters associated with a page (e.g., a page rank) are updated based on the determination that the page includes snapshot data. For example, the snapshot data of a volume snapshot may be the data stored in the volume at the time the volume snapshot is taken. The data stored in the volume at the time the volume snapshot is taken may include user data or system data. A tiering process may subsequently analyze the parameters to determine whether to migrate the page to a different storage tier. Other implementations utilize a “shared-write” to a page that is referenced by the snapshot volume. Because the page is read in order to process the write, the read page may be migrated to a different storage tier. These and other implementations are described below with respect to the figures.

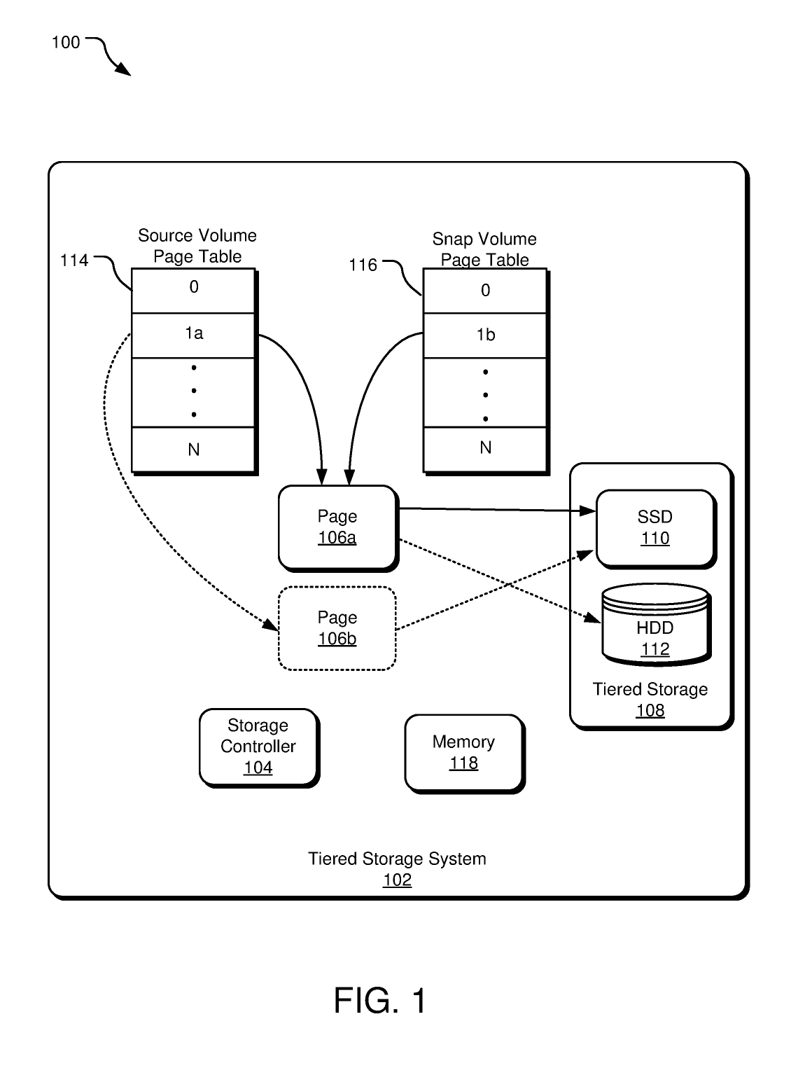

FIG. 1 illustrates a block diagram 100 of an example storage system 102 for utilizing snap-space knowledge for tiering decisions. The storage system 102 includes a storage controller 104, a memory 118, and a number of storage devices comprising a tiered storage 108. The tiered storage 108 includes a number of storage devices including a hard disc drive (HDD) 112 and a solid-state drive (SSD) 110. In example implementations, the tiered storage 108 may include many more storage devices including a plurality of SSDs and HDDs. Furthermore, the tiered storage 108 may include serial advanced technology (SATA) drives, small computer system interface (SCSI), serial attached SCSI (SAS) drives, flash drives, optical disc drives, magnetic disc drives, magnetic tape drives, solid-state hybrid drives (SSHDs), etc.

The storage system 102 utilizes virtualized volumes for storing data in the tiered storage 108. One or more virtualized volumes may be stored across the storage devices. The volumes may be thinly provisioned in that each of the volumes may have a larger storage capacity than the physical storage capacity of the tiered storage 108. In one example implementation, the storage controller 104 may be configured to allocated one virtualize volume to one client. Thus, for example, a first client may be allocated to a first volume and a second client may be allocated to a second volume. Thus, data from a client may be dispersed among one or more of the storage devices of the tiered storage 108.

Data access may be managed at a page level. For example, a host (not shown) may direct read/writes to a storage volume using pages. As such, a virtualized storage volume may include a plurality (e.g., millions) of pages. Each page may store a specified amount of data. In some example implementations, a page stores 4 MB of data. Pages of data may be stored in one of the devices of the tiered storage 108 and may be moved between storage devices based on tiering decisions, host read/write commands, etc.

The storage devices of the tiered storage 108 are allocated to a storage tier. For example, the SSD 110 is allocated to a first storage tier while the HDD 112 is allocated to the second storage tier. The storage tiers are based on read/write access time and/or storage volume. For example, data stored in the SSD 110 may be read faster than data stored in the HDD 112, while the HDD 112 stores more data than the SSD 110. The storage controller 104, which may be embedded in processor executable instructions stored in a processor readable memory, controls and manages the tiered storage 108. For example, any pages including “hot” data may be stored in the first storage tier (e.g., SSD 110) for fast access. In some example implementations, “hot” data includes data that is frequently or has been recently accessed, system data, etc. “Cold” data may be stored in the second storage tier. The storage controller 104 may utilize a number of different methods for controlling the tiered storage 108. For example, the storage controller 104 may control the tiered storage 108 using page level techniques. Such as least recently used (LRU), first in first out (FIFO), etc., which are techniques that move individual pages (or groups of pages) between storage tiers.

These tiering techniques may analyze page tables, such as a source volume page table 114) that include a listing of the pages of the volume. The page tables may indicate the location of a page at a point in time. The page table may be stored in a memory 118, a cache (not shown) or other non-volatile memory. The page tables may include or be stored in association with metadata information corresponding to each page such as I/O history (which may indicate whether the data is hot or cold). Such information may be stored as in a flash translation layer (FTL), a data heat map, a data temperature table, etc.

On a periodic/scheduled basis, the tiered storage system 102 generates “snapshots” of the one or more volumes that are stored in the storage system 102. The snapshots represent a “state” of one or more the volumes at a point in time when the snapshot is generated. The snapshots are utilized to determine which portions of a volume have been changed (deltas). Once the changed data is identified, the changed (new) data may be backed up (e.g., replicated) to a backup storage system (not shown). The snapshot data may be stored in the pages that are included as a part of the storage volume. Pages that include snapshot data may include user data or system data. The snapshot volumes are generally only used for backup/archive and are likely to receive little or no future I/O (e.g., cold data). The implementations described herein identify pages that are used for snapshot volumes and migrate such pages to a different storage tier (e.g., from the SSD 110 to the HDD 112). Thus, storage space in the storage tiers is more efficiently allocated. The identification of pages that include snapshot data and the migration of such pages may be achieved using a number of different techniques. For example, the layer of code that performs page tiering may move pages that it encounters in an upper tier to a lower tier, if the pages are used for snapshot volume data. In the same or an alternative implementation, pages may be moved to a different tier during a “shared write operation,” which saves a read of the data. The “shared write” implementation is illustrated and described in FIG. 1.

The tiered storage system 102 (e.g., the storage controller 104) generates a snapshot of a source volume, which is stored across the storage devices of the tiered storage 108. The source volume is referenced by the source volume page table 114. The source volume page table 114 includes an entry “1a,” that points to a page 106a. The page 106a is currently stored in the SSD 110, as indicated by the arrow. The snapshot generates a snap volume page table 116, which is a complete “copy” of the source volume. The snap volume page table 116 includes an entry “1b,” that also points to the page 106a. Thus, the resource is duplicated but not modified. Subsequently, the host (not shown) initiates a write to the page 106a as referenced by the source volume. Because both the source volume page table 114 and the snap volume page table 116 point to the page 106a, the write operation is referred to a “shared write.”

The tiered storage system 102 (e.g., the storage controller 104) reads the page 106a from the SSD 110 into the memory 118, creates a writable copy of the page 106a as a page 106b, writes the write data to the page 106b and updates the page table reference (e.g., the entry 1a now points to the page 106b). Because the page 106a now includes old snapshot volume data, the page may be migrated from the SSD 110 to the HDD 112. The page 106a is written to the HDD 112 and the snap volume page table 116 is updated to indicate that the page 106a is stored in the HDD 112.

In some example implementations, the page 106a is moved from the SSD 110 to the HDD 112 using a queue. For example, when the shared write occurs, the page 106a is added to an internal queue that the tiering code uses. In other implementations, the data of page 106a is read (to create the page 106b) into a buffer. The buffer data may then be written to the other tier (the HDD 112). Some bookkeeping operations may be employed when the buffer is written to the other tier. For example, the snap volume page table 116 is updated in a bookkeeping operation.

It should be understood that the page 106a may be migrated in using a number of varying types and orders of operations. In some example implementations, when the write request (to page 106a) is received, the page 106a is read into the memory 118, then written to the HDD 112. After the page 106a is written to the HDD 112, the page data (still in the memory 118) is processed to generate the page 106b, which is overwritten with the write data. In another example, the page 106a is read into the memory 118 responsive to the write request. The page 106a is then copied to create the page 106b. The write data is written to the page 106b, and the page 106a is then migrated to the HDD 112 (e.g., using queue or directly written). In another example, when the write request is received, the page 106b is created and stored in the SSD 110. Then the data of page 106a is read from the SSD 110 into the memory 118, the data of page 106a is written to the new page 106b, then the write data is written on top of the page 106b in the SSD 110. The original page 106a is then migrated to the HDD 112 (e.g., using queue or directly written). It should be understood that other migration operations are contemplated.

The above described implementations are described with respect to migration of a page from the SSD 110 to the HDD 112. However, it should be understood that a page that includes data corresponding to a volume snapshot may be preferably tiered in a higher storage tier such as the SSD 110. For example, a user or the system may be testing certain aspects of the storage system and may need to frequently access the volume snapshot data. As such, pages that include snapshot data may be tiered in the higher storage tier (and migrated from the HDD 112 to the SSD 110). Other motivations for tiering snapshot data in a higher storage tier are contemplated.

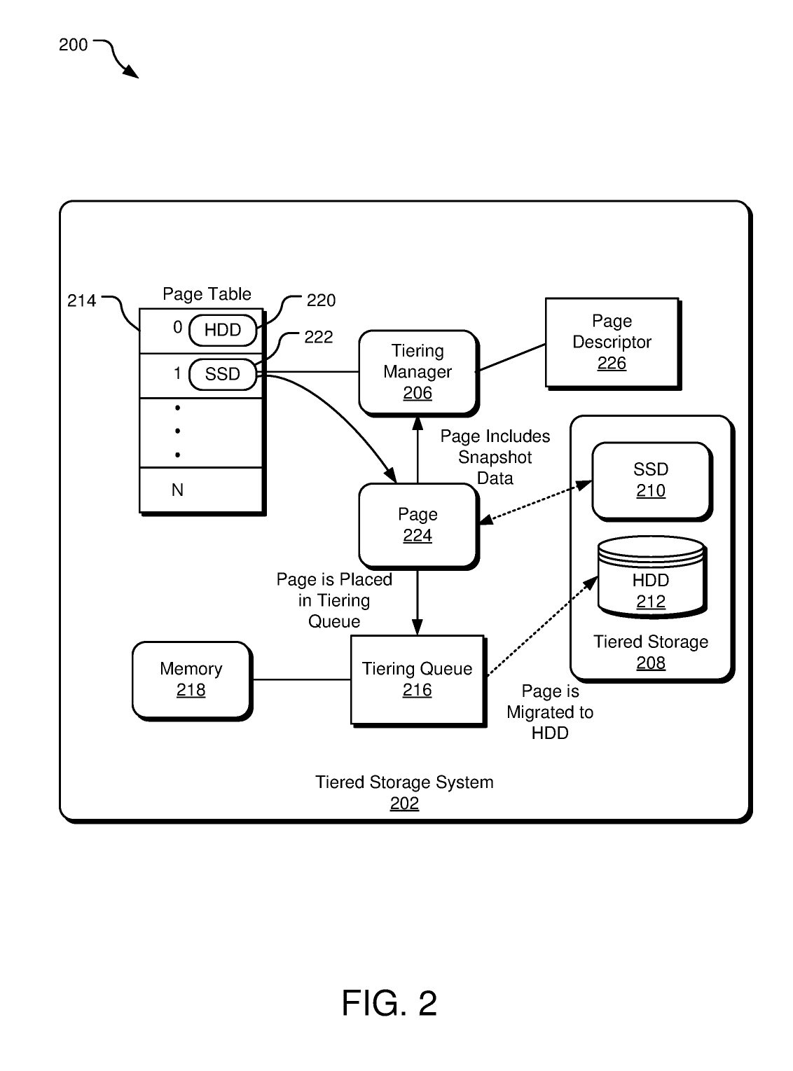

FIG. 2 illustrates another block diagram 200 of an example storage system for utilizing snap-space knowledge for tiering decisions. The storage system 202 includes a storage controller 204, a memory 218, and a number of storage devices comprising a tiered storage 208. The tiered storage 208 includes a number of storage devices including a hard disc drive (HDD) 212 and a solid-state drive (SSD) 210. In example implementations, the tiered storage 208 may include many more storage devices including a plurality of SSDs and HDDs. Furthermore, the tiered storage 208 may include serial advanced technology (SATA) drives, small computer system interface (SCSI), serial attached SCSI (SAS) drives, flash drives, optical disc drives, magnetic disc drives, magnetic tape drives, solid-state hybrid drives (SSHDs), etc.

As discussed above with respect to FIG. 1, the storage devices of the tiered storage 208 are allocated to a storage tier. For example, the SSD 210 is allocated to a first storage tier while the HDD 212 is allocated to a second storage tier. The tiers may be based on read/write access time and/or volume. One or more volumes are stored across the tiered storage 208 and is accessed using page level operations. The volume is described by a storage volume page table 214. The page table 214 may include metadata, a pointer, etc. that identifies the location of a page referenced by an entry. For example, entry 0 of the page table includes a reference 220 that identifies a page that is stored on the HDD 212. The entry 1 includes a reference 222 that identifies that page 224 is stored in the SSD 210. The reference 220 may include a pointer to a location in the SSD 210 where the page is stored. On a periodic/scheduled basis, the tiered storage system 202 generates a snapshot of the one or more volumes that are stored in the tiered storage 208. Snapshot data may be stored in one or more pages stored in the tiered storage 208.

A tiering manager 206, which may be a part of a storage controller (not shown) manages the tiered storage 208 on a page level basis. The tiering manager 206 scans the storage system 202 for hot data. If hot data is located and is stored on a low storage tier (e.g., the HDD 212), then pages storing the hot data may be migrated to a higher storage tier (e.g., to the SSD 210) by the tiering manager 206. Similarly, the tiering manager 206 migrates pages that include cold data and reference data stored in a higher storage tier (e.g., the SSD 210) to the lower storage tier (e.g., the HDD 212). In some example implementations, the tiering manager 206 utilizes a page rank (weighting or scoring) associated with each page. The page rank may be updated with each I/O directed to a page. Pages with a high page rank (e.g., above a threshold, the highest number of pages) are promoted or retained in a higher storage tier (e.g., the SSD 210). The tiering manager 206 may scan for pages with high rankings (or low rankings) for tiering on a periodic basis (e.g., every five seconds).

The tiering manager 206 also migrates pages that are used exclusively for snapshot volume data. For example, if the tiering manager 206 selects a page of data to consider for migration (e.g., based on LRU, FIFO, or other page selection technique) and the tiering manager 206 determines that page is exclusively used for snapshot volume data and is stored in the SSD 210, then the tiering manager 206 migrates the page from the SSD 210 to the HDD 212. In other words, if the tiering manager 206 encounters a page that is “snap space” and not on the lowest tier, then the tiering manager 206 may migrate the page to the lowest tier.

In some example implementations, the tiering manager 206 utilizes a tiering queue 216 to schedule pages for migration from a first storage tier to a second storage tier. For example, the tiering queue 216 may be used for pages to be migrated from the SSD 210 to the HDD 212. The tiering queue 216 may be stored in the memory 218, which may be RAM or other volatile or non-volatile memory. The tiering queue 216 may store references to pages, and the pages may be migrated using the memory 218 based on a first in first out (FIFO) basis. It should be understood that other tiering queues may be utilized, such as, for example, a tiering queue for migration of pages from the HDD 212 to the SSD 210.

In FIG. 2, the tiering manager 206 is determining whether to migrate the page referenced by entry 1 of the page table 214. The tiering manager 206 determines that the page is stored in the SSD 210 based on the reference 222. In the illustrated implementation, the page associated with entry 1 is a page 224. The tiering manager 206 may then inspect a page descriptor 226 to determine whether the page 224 includes cold data or is used for snapshot data. The tiering manager 206 determines that the page 224 is used for snapshot data. In some implementations, the page table 214 and the page table for the snapshot volume (not shown) are searched/analyzed to determine whether any pages are shared by the source volume and the snapshot volume. If a page is referenced by a snapshot volume (or shared by snapshot volumes), then the page includes snapshot data and may be migrated. If a page is referenced by a snapshot volume and a source volume, then the page includes source volume data. Because the page 224 is stored in the SSD 210 and includes snapshot data, the page 224 is placed in the tiering queue 216. In some example implementations, the page data is not placed in the tiering queue 216. Rather, a reference to the page 224 may be placed in the tiering queue 216. The tiering manager 206 then migrates the page 224 to the HDD 212. In some example implementations, a tiering queue is not utilized and the tiering manager 206 migrates the page 224.

The page descriptor 226 is a data structure that stores page rank, page statistics, etc. The page descriptor 226 may be stored in non-volatile storage in the tiered storage system 202. The page descriptor 226 may be sorted, stored in lists, queues, accessible by pages referenced by the page table 214, etc. The tiering manager 206 accesses the page descriptor 226 to determine which pages to select for migration consideration (e.g., based on page rank). Furthermore, the tiering manager 206 or other storage control process may update page ranks stored in the page descriptor 226 based on read/write requests received from a host.

In some example implementations, the tiering manager 206 utilizes I/O history of a page to determine whether to migrate the data. For example, a page with a lot of I/Os (or a high page rank) indicates that the data is ‘hot’ and should be stored in a high storage tier, such as the SSD 210. Similarly, a page with a limited number of I/Os (or a low page rank) indicates that the data is “cold” and should be stored in a low storage tier, such as the HDD 212. The tiering manager 206 may compare a metric of I/O history to a tiering condition. If the I/O history metric (or page rank) associated with a page satisfies the tiering condition (e.g., above a threshold), then the page is retained in (or migrated to) a higher storage tier, such as the SSD 210. Similarly, if the I/O history metric associated with a page does not satisfy the tiering condition (e.g., below the threshold), then the page is retained in (or migrated to) a lower storage tier, such as the HDD 212. In some example implementations, when a page stores snapshot data, the I/O metric may be weighted differently. For example, the page 224 only includes snapshot data, and thus, a tiering condition may be higher for such a page (e.g., the I/O metric must satisfy a higher threshold) to remain in the SSD 210 (e.g., not be migrated). In other words, extra preference is added to a page to be migrated to a lower tier if the page includes snapshot data.

In some example implementations, when the tiering manager 206 (or another process) encounters a page that includes snapshot data, it lowers a page rank associated with the page. For example, when a page is created for snapshot data, the page may be set to an initial low page rank compared to pages that contain user data. As such, when the tiering manager 206 encounters the page for a migration consideration, the page may not satisfy the tiering condition (e.g., a condition to be stored in the SSD 210). Accordingly, the tiering manager 206 may migrate the page to a lower tier (e.g., the HDD 212). Other processes besides the tiering manager 206 may analyze and weight (score) pages based on page content (e.g., whether the data is snapshot data) and I/O history. For example, a caching algorithm may update I/O history and/or page rank associated with the page when the page is cached for I/O.

In some example implementations that utilize snapshots for data replication (e.g., data backup to a remote location), the tiering manager 206 modifies the tiering decision to wait for a page that includes snapshot data to be over a certain age period. For example, the page 224 includes snapshot data that was generated in a recent snapshot. In a subsequent snapshot, the snapshot system (e.g., a snapshot manager (not shown)) may utilize the page 224 to determine what data stored in the volume has changed. As such, a migration decision regarding the page 224 is delayed until the subsequent volume snapshot is generated. The length of delay may depend on the period between snaps, the snapshot schedule, the volume of read/writes, etc. Similarly, snapshots may be internally managed and used by the tiered storage system 202 to perform data replication to another array. As such, pages that belong to snaps that are not yet replicated are not selected for migration.

In some example implementations, snapshots are generated based on user instruction. In such implementations, the user generates the snapshot for user access. Accordingly, the weighting for a tiering decision by the tiering manager 206 is modified based on the snapshot being mapped for user access (e.g., the page rank is increased). For example, if the page 224 includes snapshot data but is mapped for user access, the tiering manager 206 may not migrate the page 224. Such a decision may be based on a modified weighting (e.g., the I/O history is compared to a lower threshold because of the user access mapping).

In some example implementations, snapshot data is used and managed by the tiered storage system 202. The tiered storage system 202 may be configured to manage the snap data and thus, places a higher tier preference on such data (e.g. the page rank associated with the page is increased). Accordingly, a tiering decision by the tiering manager 206 considers whether the snapshot data is used by the storage system when determining whether to migrate data.

In some example implementations, the user or system sets a tiering affinity (e.g. a tiering preference) for a volume of data. Tiering affinity is a volume attribute that makes it more likely for a volume's pages to be placed on a specific tier. Tiering affinity preferences include an archive affinity (e.g., affinity towards the lowest tier such as the HDD 212), no affinity (e.g., operate within the parameters of the default tiering algorithm), and performance (e.g., affinity towards the highest tier for random I/O). It should be understood that other affinity preferences may be defined. Snapshots of volumes generally inherit the tier preference from the base/source volume (since pages are shared). A page that is shared between a base volume and a snapshot volume may be given the preference of the base volume. In some implementations, when the page is no longer shared (e.g., after a shared write), the old non-shared page may be assigned a new tier preference (e.g., assigned a lower tier preference). As such, the tiering manager 206 considers the tiering preference when determining whether to migrate pages between tiers.

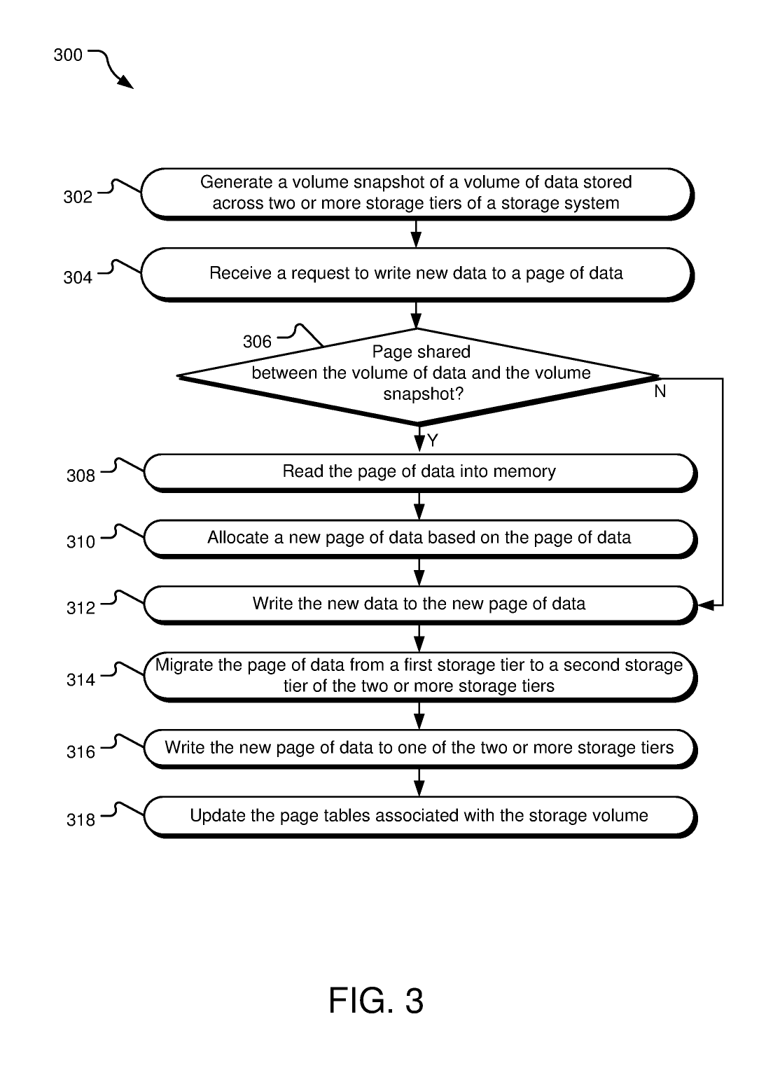

FIG. 3 illustrates example operations 300 for utilizing snap space knowledge in tiering decisions. Specifically, FIG. 3 illustrates the operations 300 for a shared page write migration. A generating operation 302 generates a volume snapshot of a volume of data stored on a storage system with two or more storage tiers. A receiving operation 304 receives a request to write new data to a page of data shared between the volume of data and the volume snapshot. A determining operation 306 determines whether the page is shared between the volume of data and the volume snapshot. The determining operation 306 may be performed by analyzing the volume of data page table and the snapshot page table. If the page is shared between the volume of data and the volume snapshot, a reading operation 308 reads the page of data into memory. In some example operations, an I/O manager receives the write request, determines that the page is shared, and notifies a tiering manager that the page includes snapshot data. The tiering manager may then migrate the page or schedule the page for migration. An allocating operation 310 allocates a new page of data based on the page of data. A writing operation 312 writes the new data to the new page of data. The page of data may be copied and the new page of data may be generated in a storage tier such as the SSD or stored in a cache. Similarly, the data of the page of data may be copied in memory (e.g., RAM) and the new write data may be written to the copy in memory. Afterwards, the data (with the new write data) may be written to a storage tier as the new page of data. If the page is not shared between the volume snapshot and the volume of data (e.g., in the determining operation 306), then a writing operation 312 writes the new data to the page of data. The writing operation 312 may including reading the page into memory then rewriting to the storage tier.

A migrating operation 314 migrates the page of data (e.g., the old data) from a first storage tier to a second storage tier of the two or more storage tiers because the page of data contains snapshot data. The migrating operation may utilize a tiering queue or the data may be written directly from a buffer to the second storage tier. A writing operation 316 writes the new page to one of the two or more storage tiers. An updating operation 318 updates the page table(s) associated with the storage table. The updating operation 318 may include remapping the pages to the respective tiers, updating page ranks associated with the pages, etc.

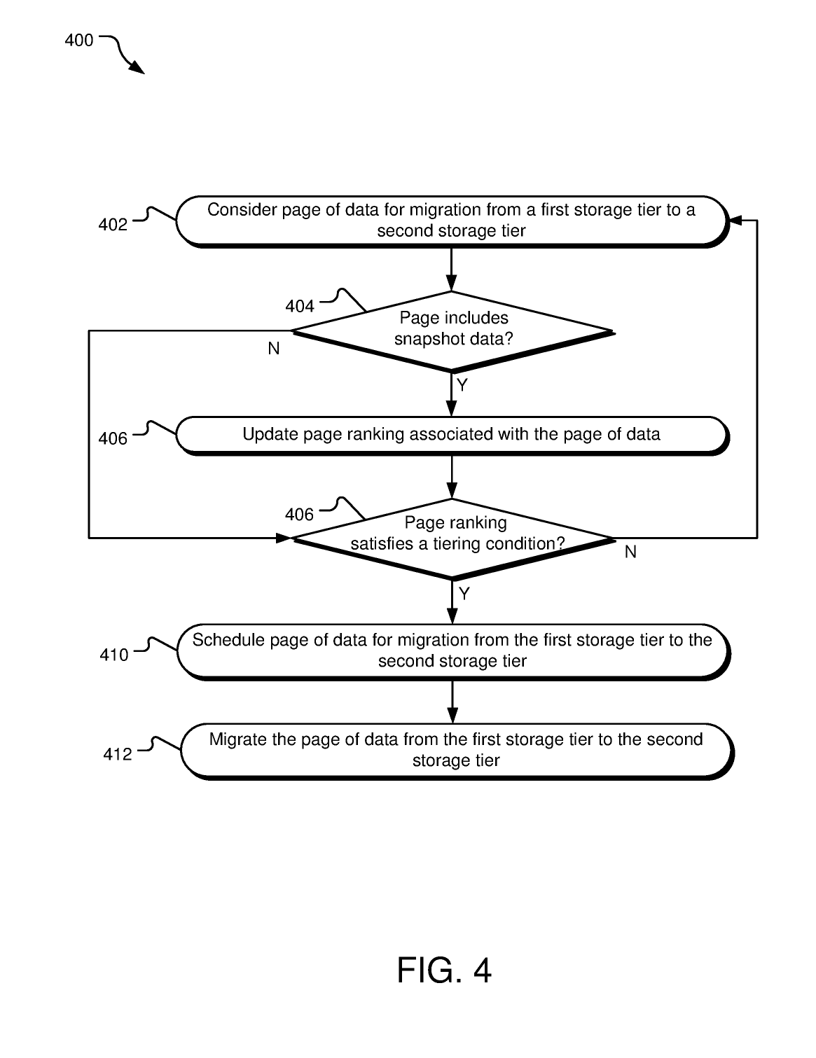

FIG. 4 illustrates example operations 400 for utilizing snap space knowledge in tiering decisions. A considering operation 402 considers a page of data for migration from a first storage tier to a second storage tier. A determining operation 404 determines whether the page of data includes snapshot data. The determining operation 404 may be performed by analyzing the volume of data page table and the snapshot page table to determine whether the page is shared between the source volume and the snapshot volume or whether the page is referenced by a snapshot volume or shared between snapshot volumes. If the page of data includes a snapshot data, an updating operation 406 updates a page ranking or other parameter associated with the page of data. The page rank may be stored in a page descriptor or other data structure. If the page does not include snapshot data (e.g., includes user data), then a determining operation 408 determines whether the page ranking satisfies a tiering condition. Furthermore, after the page ranking is updated in the updating operation 406, the determining operation 408 determines whether the page ranking satisfies a tiering condition. If the page ranking satisfies a tiering condition (e.g., the page ranking is above or below a threshold for the page's current tier), then a scheduling operation 410 schedules the page of data for migration from the first storage tier to the second storage tier. A migrating operation 412 migrates the page of data from the first storage tier to the second storage tier. If the page ranking does not satisfy a tiering condition (e.g., is above or below a threshold for the page's current tier), then the process returns to the considering operation 402 which considers a new page of data for migration.

The operations 400 may be performed by different entities. For example, an I/O process (e.g., an I/O manager), page management process, or a storage controller may update rankings based on I/O and consideration of page data (e.g., whether the data is snapshot data). Furthermore, a different process may analyze and process pages for migration based on page rankings. A tiering process may sequentially or otherwise select pages for migration consideration and determine whether the page rankings satisfy a condition. In some example implementations, page with page rankings above/below a threshold are migrated automatically by a tiering process, I/O process, etc. In implementations, instead of updating the page rank of a page that includes snapshot data, the tiering condition is adjusted. Other methods of adjusting tiering decisions based on snapshot data are contemplated.

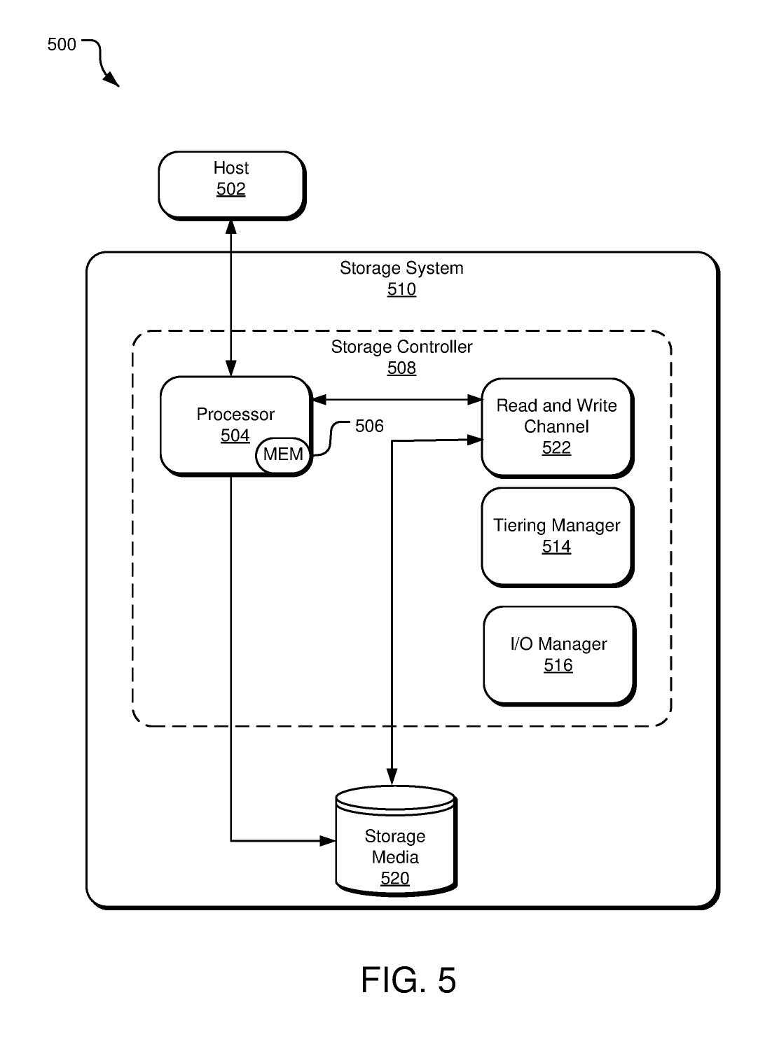

FIG. 5 illustrates an example schematic 500 of a storage controller 508 of a storage system 510. Specifically, FIG. 5 shows one or more functional circuits that are resident on a printed circuit board used to control the operation of the storage system 510. The storage controller 508 may be operably and communicatively connected to a host computer 502. Control communication paths are provided between the host computer 502 and a processor 504. Control communication paths are provided between the processor 504 and the storage devices 520 via a number of read/write channels (e.g., read and write channel 522). The processor 504 generally provides top-level communication and control for the storage controller 508 in conjunction with processor-readable instructions for the processor 504 encoded in processor-readable storage media (e.g., a memory 506). The processor readable instructions further include instructions for using snap space knowledge for tiering in the storage devices 520 and instructions for generating volume snapshots, tiering pages of data based on snapshot data, analyzing pages to update page parameters (e.g., page ranks), processing shared writes, analyzing user preferences (e.g., tiering preferences), etc.

The term “processor-readable storage media” includes but is not limited to, random access memory (“RAM”), ROM, EEPROM, flash memory or other memory technology, CDROM, digital versatile discs (DVD) or other optical disc storage, magnetic cassettes, magnetic tape, magnetic disc storage or other magnetic storage devices, or any other tangible medium which can be used to store the desired information and which can be accessed by a processor. In contrast to tangible processor-readable storage media, intangible processor-readable communication signals may embody processor-readable instructions, data structures, program modules or other data resident in a modulated data signal, such as a carrier wave or other signal transport mechanism.

The storage controller 508 controls storage of data on the storage devices 520 such as HDDs, SSD, SSHDs, flash drives, SATA drives etc. Each of the storage devices may include spindle motor control circuits for controlling rotation of media (e.g., discs) and servo circuits for moving actuators between data tracks of storage media of the storage devices 520.

Other configurations of storage controller 508 are contemplated. For example, storage controller 508 may include one or more of an interface circuitry, a buffer, a disc drive, associated device peripheral hardware, an encryption unit, a compression unit, a replication controller, etc. The storage controller 508 includes a tiering manager 514 that controls tiering decisions based on snap space knowledge. The storage controller 508 also includes an I/O manager that receives write requests to pages, determines whether the pages are shared pages, performs shared write operations, and schedules pages for migration. The tiering manager 514 and the I/O manager 516 may be embodied in processor-readable instructions stored in the memory 506 (a processor-readable storage media) or another processor-readable memory.

In addition to methods, the embodiments of the technology described herein can be implemented as logical steps in one or more computer systems. The logical operations of the present technology can be implemented (1) as a sequence of processor-implemented steps executing in one or more computer systems and/or (2) as interconnected machine or circuit modules within one or more computer systems. Implementation is a matter of choice, dependent on the performance requirements of the computer system implementing the technology. Accordingly, the logical operations of the technology described herein are referred to variously as operations, steps, objects, or modules. Furthermore, it should be understood that logical operations may be performed in any order, unless explicitly claimed otherwise or unless a specific order is inherently necessitated by the claim language.

Data storage and/or memory may be embodied by various types of storage, such as hard disc media, a storage array containing multiple storage devices, optical media, solid-state drive technology, ROM, RAM, and other technology. The operations may be implemented in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A method comprising:
determining whether a page includes snapshot data, the snapshot data corresponding to a snapshot of a volume of data stored across a plurality of storage devices of a storage system, each of the plurality of storage devices being allocated to one of at least a first storage tier and a second storage tier; and
migrating the page from the first storage tier to the second storage tier of the storage system responsive to determining that the page includes snapshot data.

2. The method of claim 1 wherein determining whether the page includes snapshot data further comprises:
receiving a write request to write new data to the page; and
determining that the page is shared between the volume of data and the snapshot.

3. The method of claim 2 further comprising:
reading the page into memory before migrating the page from the first storage tier to the second storage tier; and
allocating a new page including the new data; and
writing the new page including the new data to the first storage tier.

4. The method of claim 1 further comprising:
updating a page rank associated with the page responsive to determining that the page includes the snapshot data; and
determining whether the page rank associated with the page satisfies a tiering condition, the page being migrated responsive to determining that the page rank associated with the page satisfies the tiering condition.

5. The method of claim 1 further comprising:
delaying the migration of the page until a subsequent volume snapshot is generated.

6. The method of claim 1 further comprising:
updating a tiering affinity associated with the page, the tiering affinity indicating one of the first storage tier or the second storage tier of the storage system, the tiering affinity used to determine whether to migrate the page.

7. The method of claim 1, further comprising:
updating a parameter associated with the page responsive to determining that the page includes the snapshot data, the parameter used to determine whether to migrate the page from the first storage tier to the second storage tier.

8. One or more processor-readable storage media encoding processor-executable instructions for executing on a computer system a computer process, the computer process comprising:
determining whether a page includes snapshot data, the snapshot data corresponding to a snapshot of a volume of data stored across a plurality of storage devices of a storage system, each of the plurality of storage devices being allocated to one of at least a first storage tier and a second storage tier; and
migrating the page from the first storage tier to the second storage tier of the storage system responsive to determining that the page includes snapshot data.

9. The one or more processor-readable storage media of claim 8 determining whether the page includes snapshot data further comprises:
receiving a write request to write new data to the page; and
determining that the page is shared between the volume of data and the snapshot.

10. The one or more processor-readable storage media of claim 9 further comprising:
reading the page into memory before migrating the page from the first storage tier to the second storage tier; and
allocating a new page including the new data; and
writing the new page including the new data to the first storage tier

11. The one or more processor-readable storage media of claim 8 further comprising:
updating a page rank associated with the page responsive to determining that the page includes the snapshot data; and
determining whether the page rank associated with the page satisfies a tiering condition, the page being migrated responsive to determining that the page rank associated with the page satisfies the tiering condition.

12. The one or more processor-readable storage media of claim 8 further comprising:
adding the page to a tiering queue to schedule the page for the migrating the page from the first storage tier to the second storage tier.

13. The one or more processor-readable storage media of claim 8 further comprising:
updating a tiering affinity associated with the page, the tiering affinity indicating one of the first storage tier or the second storage tier of the storage system, the tiering affinity used to determine whether to migrate the page.

14. The one or more processor-readable storage media of claim 8 further comprising:
updating a parameter associated with the page responsive to determining that the page includes the snapshot data, the parameter used to determine whether to migrate the page from the first storage tier to the second storage tier.

15. A storage system comprising:
one or more processors;
a plurality of storage devices allocated to two or more storage tiers; and
a tiering manager executable by the one or more processors to a page includes snapshot data corresponding to a volume snapshot of a volume of data stored across the plurality of storage devices and migrate the page from a first storage tier to a second storage tier of the two or more storage tiers responsive to deter mining that the page includes snapshot data.

16. The storage system of claim 15 further comprising:
an I/O manager executable by the one or more processors to receive a write request to write new data to the page, to determine that the page is shared between the volume of data and the volume snapshot, and to notify the tiering manager that the page includes snapshot data.

17. The storage system of claim 15 wherein the tiering manager is further executable to update a page rank associated with the page responsive to determining that the page includes the snapshot data and to determine whether the page rank associated with the page satisfies a tiering condition, the page being migrated responsive to determining that the page rank associated with the page satisfies the tiering condition.

18. The storage system of claim 15 wherein the tiering manager is further executable to add the page to a tiering queue to schedule the page for migration from the first storage tier to the second storage tier.

19. The storage system of claim 15 wherein the tiering manager is further executable to delay migration of the page until a subsequent volume snapshot is generated.

20. The storage system of claim 15 wherein the tiering manager is further executable to update a parameter associated with the page responsive to determining that the page includes the snapshot data, the parameter used to determine whether to migrate the page from the first storage tier to the second storage tier.
